(19) United States
(12) Patent Application Publication
(10) Pub. No.: US 2007/0114932 A1
(43) Pub. Date: May 24, 2007

(54) FRONT FILTER OF PLASMA DISPLAY PANEL AND FABRICATION METHOD THEREOF

(76) Inventor: Kyung Ku Kim, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 11/626,278

(22) Filed: Jan. 23, 2007

Related U.S. Application Data
(63) Continuation of application No. 10/821,375, filed on Apr. 8, 2004.

(30) Foreign Application Priority Data
Apr. 10, 2003 (KR) 2003-0022685

(51) Int. Cl. H01J 17/49

(52) U.S. Cl. 313/582

(57) ABSTRACT

Disclosed are a front filter of a plasma display panel capable of correctly forming an active display area of the plasma display panel, and a fabrication method thereof. To this end, a frame adhesive forming the active display area of the plasma display panel is formed on at least one thin film among a plurality of thin films of the front filter.

### BACKGROUND OF THE INVENTION

1. Field of the Invention

The present invention relates to a plasma display panel, and more particularly, to a front filter of a plasma display panel and a fabrication method thereof.

2. Description of the Conventional Art

Generally, a plasma display panel (PDP) is for displaying an image including letters or a graphic by emitting light from phosphor by vacuum ultraviolet rays (Vuv) of 147 nm generated when gas such as He+Xe, Ne+Xe, He+Ne+Xe, and etc. is discharged. The PDP is being spotlighted as a large flat display due to a thin film realization and a scale-up realization.

FIG. 1 shows a structure of a PDP of a three-electrode alternating current (AC) method in accordance with the conventional art.

As shown, the PDP comprises: a lower glass substrate 1; an address electrode 2 formed at a part on the lower glass substrate 1; a lower dielectric layer 9 formed on the entire surfaces of the lower glass substrate 1 and the address electrode 2; a barrier rib 3 defined at a part on the lower dielectric layer 9 so as to respectively divide a plurality of discharge cells; a fluorescent layer 8 formed on the barrier rib 3 with a predetermined thickness for emitting visible rays of R, G, and B by receiving ultraviolet rays; an upper glass substrate 7; a scan electrode 6-1 and a sustain electrode 6-2 formed at a part on the upper glass substrate 7 to be perpendicular to the address electrode 2; an upper dielectric layer 5 formed on the entire scan electrode 6-1, the sustain electrode 6-2, and the upper glass substrate 2; and a protective layer 4 formed on the upper dielectric layer 5 for protecting the upper dielectric layer 5. The scan electrode 6-1 is composed of a transparent electrode 6-1A formed at a certain part on the upper glass substrate 2, and a metal bus electrode 6-1B formed at a part on the transparent electrode 6-1A. The sustain electrode 6-2 is composed of a transparent electrode 6-2A formed at a part of the upper glass substrate 2, and a metal bus electrode 6-2B formed at a part of the transparent electrode 6-2A. Herein, the scan electrode 6-1 and the sustain electrode 6-2 are called as a sustain electrode pair (6-1, 6-2). The metal bus electrodes 6-1 B and 6-2B of the scan electrode 6-1 and the sustain electrode 6-2 are installed at a discharge space of one cell.

Hereinafter, operation of a plasma display panel composed of an upper substrate 10 and a lower substrate 20 will be explained.

The upper glass substrate 7 and the lower glass substrate 1 are disposed in parallel with a certain gap. Mixed gas is injected into a discharge space between the upper glass substrate 7 and the lower glass substrate 1. The fluorescent layer 8 for emitting light when the mixed gas is discharged is deposited on the barrier rib 3.

On the upper glass substrate 7, the upper dielectric layer 5 and the protecting layer 4 are sequentially stacked. The sustain electrode pair 6-1 and 6-2 composed of the metal bus electrodes 6-1B and 6-2B and the transparent electrodes 6-1A and 6-2A and formed between the upper glass substrate 7 and the upper dielectric layer 5 are disposed in parallel in a perpendicular direction to the address electrode 2. The transparent electrodes 6-1A and 6-2A are formed on the upper glass substrate 7, and the metal bus electrodes 6-1B and 6-2B are formed at parts on the transparent electrodes 6-1A and 6-2A.

The address electrode 2 is formed on the lower glass substrate 1, and the lower dielectric layer is stacked on the entire surfaces of the lower glass substrate 1 and the address electrode 2. The barrier rib 3 is extended on the lower dielectric layer 9 under a state that the address electrode 2 is interposed therebetween.

The barrier rib 3 formed on the lower dielectric layer 9 shields an electrical and optical interference between cells, and forms a discharge space inside a cell by being formed between the glass substrate 7 and the lower glass substrate 1.

The fluorescent layer 8 deposited on the barrier rib 3 is excited by a vacuum ultraviolet rays of a short wavelength generated when gas inside the discharge space is discharged thus to generate visible rays of three colors. According to this, three primary colors of R, G, and B are emitted from each cell.

The upper dielectric layer 5 and the lower dielectric layer 9 accumulate an electric charge when the gas is discharged. The protective layer 4 protects the upper dielectric layer 5 from a sputtering phenomenon of plasma particles when the gas is discharged, and is mainly formed of magnesium oxide (MgO).

The sustain electrode pair 6-1 and 6-2 generate a discharge by a voltage applied to the sustain electrode pair 6-1 and 6-2 after an address discharge thereby to sustain the discharge. The transparent electrodes 6-1A and 6-2A constituting the sustain electrode pair 6-1 and 6-2 are formed of a transparent conductive material having a light transmittance more than 90% (for example, indium-tin-oxide, ITO) thus to pass most of visible rays emitted from the fluorescent layer 8. However, the material such as ITO has a low conductive ratio even if the light transmittance is high thus to have a very high resistance value, thereby not transmitting an electric power efficiently. To solve this problem, the metal bus electrodes 6-1B and 6-2B formed of a high conductive material such as Ag or Cu are disposed on the transparent electrode 6A. The metal bus electrodes 6-1B and 6-2B drop resistance values of the sustain electrode pair 6-1 and 6-2 thus to prevent a voltage drop resulting from high resistance values of the transparent electrodes 6-1 A and 6-2A.

Hereinafter, a glass-type front filter installed on the upper substrate 10 of the PDP for shielding an electromagnetic wave and preventing a reflection of external light will be explained with reference to FIG. 2.

FIG. 2 is a sectional view showing the glass type front filter attached to the PDP of FIG. 1.

As shown, the glass type front filter 30 for shielding an electromagnetic wave generated from the PDP towards the front surface side thereof, preventing a reflection of external light, shielding near infrared rays, and correcting colors is installed on the upper substrate 10 of the PDP.

The glass type front filter 3 comprises: a glass substrate 32; a first antireflection layer 31 attached to a front surface of the glass substrate 32; an electromagnetic shielding layer 34 attached to a rear surface of the glass substrate 32; a near infrared shielding layer 36; and a second antireflection layer 37. A black frame 33 for determining an active display area of the PDP is formed to be overlapped with a ground electrode 35. The active display area means an area that an image is actually displayed on the PDP.

The glass substrate 32 is used as a tempered glass, supports the glass type front filter 30, and protects the front filter 30 and the PDP from an external impact.

The first and second antireflection layers 31 and 37 prevent light which has been incident from outside from being reflected outside and thus to increase a contrast.

The electromagnetic shielding layer 34 absorbs an electromagnetic wave generated form the PDP thus to shield the electromagnetic wave from being emitted to outside.

The near infrared shielding layer 36 absorbs near infrared rays of approximately 800˜1000 nm wavelength generated from the PDP thus to shield a near infrared rays emitted to outside, thereby making controlling infrared rays (approximately 947 nm) generated from a remote control and etc. be normally inputted to an infrared rays reception portion (not shown) installed at the PDP set without an interference of the near infrared rays. Also, the near infrared shielding layer 36 controls hue by a color dye. The near infrared shielding layer 36 can be integrally formed with a color correction layer for enhancing a color purity or can be additionally formed. The plurality of thin films 31, 34, 36, and 37 are formed on a base film (not shown) thus to be attached on the glass substrate 32 by an adhesive or an agglutinant.

However, since the glass type front filter 30 includes the thick glass substrate 32, that is, the tempered glass, the entire thickness and weight of the PDP set are increased and a fabrication cost is increased. Therefore, as shown in FIG. 3, a film type front filter that the glass substrate 32 has been removed was proposed.

FIG. 3 is a sectional view showing the filter type front filter attached to the PDP of FIG. 1.

As shown, the film type front filter 40 comprises the near infrared shielding layer 36, the electromagnetic shielding layer 34, and the antireflection layer 37 which are sequentially attached to the upper substrate 10 of the PDP. Also, the black frame 33 for determining the active display area of the PDP is formed to be overlapped with the ground electrode 35.

The antireflection layer 37 prevents light which has been incident from outside from being reflected outside.

The electromagnetic shielding layer 34 absorbs an electromagnetic wave generated form the PDP thus to shield the electromagnetic wave from being emitted to outside.

The near infrared shielding layer 36 absorbs near infrared rays generated from the PDP thus to shield a near infrared rays emitted to outside. Also, the near infrared shielding layer 36 controls hue by a color dye. The near infrared shielding layer 36 can be integrally formed with a color correction layer for enhancing a color purity or can be additionally formed. The plurality of thin films 37, 34, and 36 are formed on a base film (not shown) thus to be attached on the upper substrate 10 of the PDP by an adhesive or an agglutinant.

The black frame 33 of the glass type front filter 30 is formed by printing a black ceramic on the glass substrate 32 thus to be seen at the front surface of the glass type front filter 30. According to this, the black frame 33 of the glass type front filter forms the active display area so as to visually clarify a screen outline. However, since the filter type front filter 40 is directly attached to the upper substrate 10 of the PDP, the ground electrode 35 is exposed. Therefore, the black frame 33 that forms the active display area of the PDP is formed to be overlapped with the ground electrode 35, so that colors of the ground electrode 35 are visible to a user's eyes and thereby the active display area can not be precisely formed,

As aforementioned, in the glass type front filter 30 according to the conventional art, the thick tempered glass substrate 32 is used thus to increase the entire thickness and weight of the PDP set and to increase the fabrication cost.

Also, in the filter type front filter 40 according to the conventional art, the black frame 33 that forms the active display area of the PDP is formed to be overlapped with the ground electrode 35, so that colors of the ground electrode 35 are visible to the user's eyes and thereby the active display area can not be precisely formed.

Another plasma display panel and a fabrication method thereof in accordance with the conventional art have been disclosed in U.S. Pat. No. 5,838,106 which has been registered in Nov. 17, 1998, U.S. Pat. No. 6,242,859 which has been registered in Jun. 5, 2001, and U.S. Pat. No. 6,344,080 which has been registered in Feb. 5, 2002.

### SUMMARY OF THE INVENTION

Therefore, an object of the present invention is to provide a front filter of a plasma display panel capable of precisely form an active display area of the plasma display panel and a fabrication method thereof.

To achieve these and other advantages and in accordance with the purpose of the present invention, as embodied and broadly described herein, there is provided a front filter of a plasma display panel, in the front filter attached to a front surface of the plasma display panel and formed of a plurality of thin films, the front filter is formed on at least one thin film among the plurality of thin films and is constituted with a frame adhesive for forming an active display area of the plasma display panel.

The front filter of a plasma display panel according to the present invention comprises: a near infrared shielding layer formed on a plasma display panel; an electromagnetic shielding layer and a ground electrode formed on the near infrared shielding layer; a frame adhesive formed on the electromagnetic shielding layer; and an antireflection layer attached onto the frame adhesive, wherein the ground electrode is positioned outside an active display area of the plasma display panel.

To achieve these and other advantages and in accordance with the purpose of the present invention, as embodied and broadly described herein, there is also provided a fabrication method of a front filter of a plasma display panel comprising the steps of: fabricating a frame adhesive composed of a transparent adhesive formed at an area that is overlapped with an active display area of a plasma display panel, and a black adhesive formed at an area except the active display area; and forming the frame adhesive on at least one thin film among a plurality of thin films constituting the front filter of the plasma display panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a structure of a PDP of a three-electrode alternating current (AC) method in accordance with the conventional art;

FIG. 2 is a sectional view showing a glass type front filter attached to the PDP of FIG. 1;

FIG. 3 is a sectional view showing a filter type front filter attached to the PDP of FIG. 1;

FIG. 4 is a sectional view showing a front filter of a PDP according to the present invention;

FIGS. 5A and 5B are views showing a fabricating process of a frame adhesive of a front filter according to a first embodiment of the present invention;

FIGS. 6A and 6B are views showing a fabricating process of the frame adhesive of the front filter according to a second embodiment of the present invention;

FIGS. 7A-7C are views showing a fabricating process of the frame adhesive of the front filter according to a third embodiment of the present invention; and

FIG. 8 is a sectional view showing a glass type front filter having a frame adhesive according to the present invention.

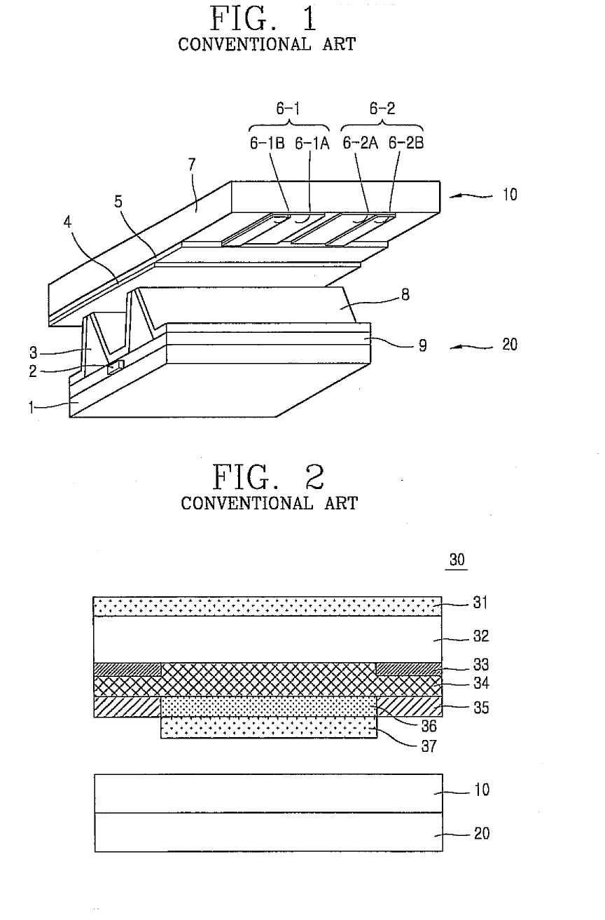

### DETAILED DESCRIPTION OF THE PREFERRED EMBODIMENTS

Reference will now be made in detail to the preferred embodiments of the present invention, examples of which are illustrated in the accompanying drawings.

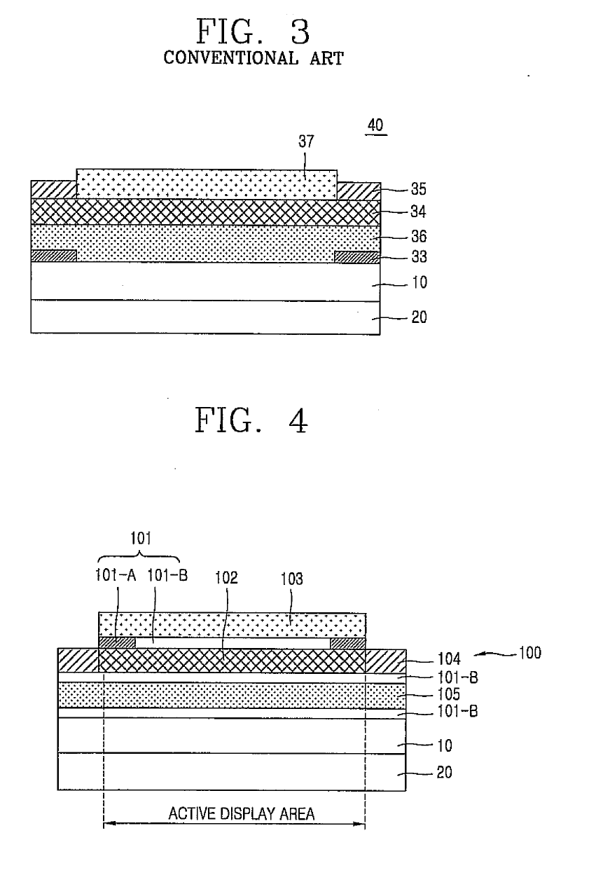

Hereinafter, with reference to FIGS. 4 to 8, will be explained a front filter of a plasma display panel (PDP) capable of precisely forming an active display area of the PDP by forming a frame adhesive composed of a transparent adhesive formed at an area that is overlapped with an active display area of a plasma display panel and a black adhesive formed at an area except the active display area on at least one thin film among a plurality of thin films constituting the front filter of the PDP, and a method thereof.

FIG. 4 is a sectional view showing a front filter of a PDP according to the present invention.

As shown, the front filter 100 of the PDP according to the present invention comprises: a near infrared shielding layer 105 attached onto an upper substrate 10 of the PDP by a transparent adhesive 101-B; an electromagnetic shielding layer 102 and a ground electrode 104 attached onto the near infrared shielding layer 105 by the transparent adhesive 101-B; a frame adhesive 101 formed on the electromagnetic shielding layer 102; and an antireflection layer 103 attached onto the frame adhesive 101. The frame adhesive 101 is composed of a transparent adhesive 101-B formed on an active display area of the PDP, and a black adhesive 101-A formed outside the active display area. The ground electrode 104 is positioned outside the active display area.

Hereinafter, a construction of the front filter of the PDP according to the present invention will be explained in more detail.

The antireflection layer 103 prevents light which has been incident from outside from being reflected outside.

The electromagnetic shielding layer 102 absorbs an electromagnetic wave generated form the PDP and discharge the electromagnetic wave thus to shield the electromagnetic wave from being emitted to outside.

The near infrared shielding layer 105 absorbs near infrared rays of approximately 700˜1200 nm wavelength generated from the PDP thus to shield a near infrared rays emitted to outside, thereby making controlling infrared rays (approximately 947 nm) generated from a remote control and etc. be normally inputted to an infrared rays reception portion (not shown) installed at the PDP set without an interference of the near infrared rays. Also, the near infrared shielding layer 106 controls hue by a color dye. The near infrared shielding layer 106 can be integrally formed with a color correction layer for enhancing a color purity or can be additionally formed, The color correction layer has a wavelength of 560˜620 nm.

The plurality of thin films 103, 102, and 105 are formed on a base film (not shown) thus to be attached on an upper substrate 10 of the PDP by an adhesive or an agglutinant. The upper substrate 10 and the lower substrate 20 constituting the PDP are attached to each other so that a gas discharge space can be formed therein, and an image is displayed by a discharge of the gas.

The frame adhesive 101 for adhering the plurality of thin films 103, 102, and 105 is composed of a transparent adhesive 101-B and a black adhesive 101-A. The frame adhesive 101 is formed between the electromagnetic shielding layer 102 and the antireflection layer 103. The transparent adhesive 101-B is formed between the upper substrate 10 of the PDP and the near infrared shielding layer 105, and is formed between the electromagnetic shielding layer 102 and the near infrared shielding layer 105.

So as to form an active display area for visually clarifying a screen outline, the frame adhesive 101 is composed of a transparent adhesive formed at an area that is overlapped with the active display area of the plasma display panel, and a black adhesive formed at an area except the active display area. For example, the black adhesive 101-A of the frame adhesive is formed by mixing a black material with the transparent adhesive 101-B. That is, the black adhesive 101-A of the frame adhesive is formed by mixing a black material of approximately 0.01˜50% with the transparent adhesive 101-B. The black material is one of titanium oxide (Rutile phase, Anatase phase), cadmium yellow, chrome yellow, cadmium red, iron oxide, phthalocyanine green, phthalocyanine blue, phthalocyanine navy blue, carbon black, cobol blue/violet, mineral violet, chromium oxide, carbon, aniline black, azo pigment, azo dye, azo compound, azo basic pigment, metal complex salts, and metal oxide. The black material can be formed of aniline-formaldehyde resin, aryl group, or arylation reaction resin. Also, the black material can be formed of a mineral-added material such as Nd₂O₃, Nd group, Fe and iron oxide, Ag and silver oxide, Ni and nickel oxide, and Cr and chrome oxide.

The transparent adhesive 101-B is preferably one-selected among acrylic group adhesive, rubber group adhesive, a vinyl group adhesive, and silicon group adhesive. Also, the transparent adhesive can be one-selected among solvent type agglutinant, pressure sensitive agglutinant, thermal sensitive agglutinant, and reactive agglutinant.

Hereinafter, a fabrication process of the frame adhesive of the front filter according to the present invention will be explained.

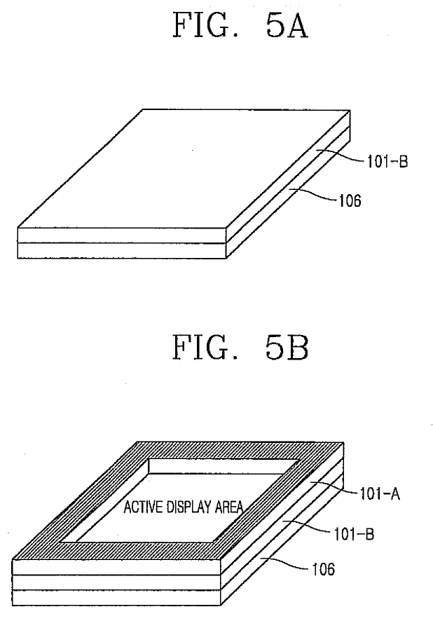

FIGS. 5A and 5B are views showing a fabricating process of the frame adhesive of the front filter according to a first embodiment of the present invention.

As shown in FIG. 5A, the transparent adhesive 101-B is printed on the entire surface of a base film 106 formed by polyethylene terepthalate and etc.

As shown in FIG. 5B, the black adhesive 101-A is printed on an outer periphery area of an active display area of the transparent adhesive 101-B thus to form the active display area of the PDP.

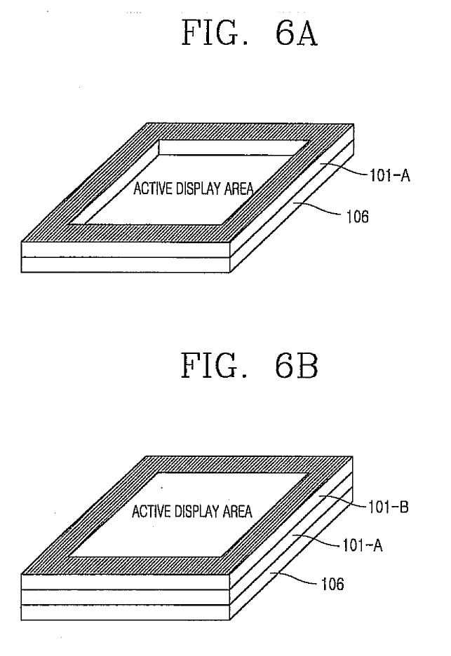

FIGS. 6A and 6B are views showing a fabricating process of the frame adhesive of the front filter according to a second embodiment of the present invention.

As shown in FIG. 6A, the black adhesive 101-A is printed on the base film 106 formed by PET and etc. along an outer periphery area of an active display area of the base film 106.

As shown in FIG. 6B, the transparent adhesive 101-B is printed on the entire surface of the base film 107 on which the black adhesive 101-A is printed. The black adhesive 101-A of the frame adhesive 101 is printed on the outer periphery area of the base film 106, thereby forming the active display area of the PDP.

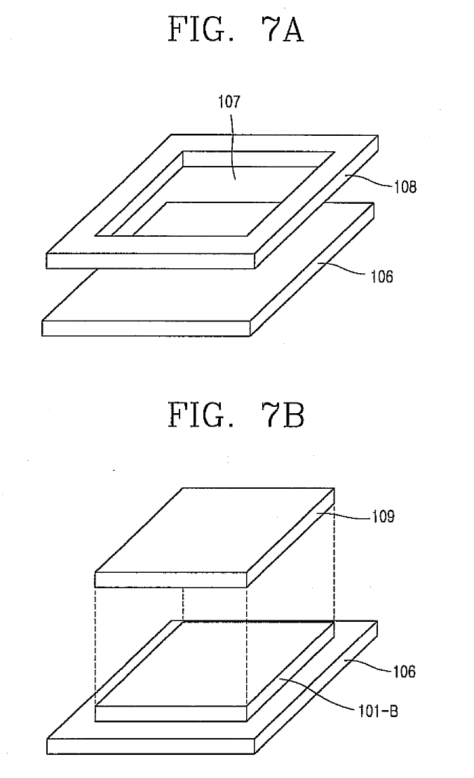

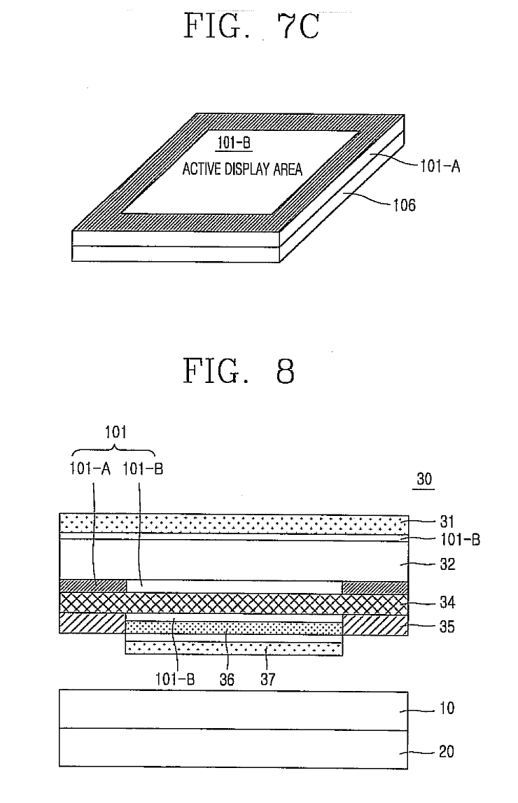

FIGS. 7A and 7B are views showing a fabricating process of the frame adhesive of the front filter according to a third embodiment of the present invention.

As shown in FIG. 7A, a first screen mask 108 having a hole 107 of the same form as the active display area is aligned on the base film 106 formed by PET and etc,

As shown in FIG. 7B, the transparent adhesive 101-B is printed on the base film 106 through the first screen mask 108, thereby forming the transparent adhesive 101-B on the base film 106. A second screen mask 109 for shielding an area overlapped with the transparent adhesive 101-B is aligned on the base film 106 on which the transparent adhesive 101-B is formed.

As shown in FIG. 7C, the black adhesive 101-A is printed on the base film 106 through the second screen mask 109, thereby forming the black adhesive 101-A on the base film 106 except the transparent adhesive 101-B. The black adhesive 101-A is printed on the periphery area of the base film 106, thereby forming the active display area of the PDP. The black adhesive 101-A and the transparent adhesive 101-B can be simultaneously formed by one mask. The black adhesive and the transparent adhesive can be formed not only a printing method but also a laminating method or a pressing method by an adhesive sheet or an agglutinant sheet.

The frame adhesive according to the present invention can be formed on one thin film among a plurality of thin films of not only the film type front filter but also the conventional glass type front filter.

FIG. 8 is a sectional view showing a glass type front filter having a frame adhesive according to the present invention.

As shown in FIG. 8, the frame adhesive can be formed between the electromagnetic shielding layer 34 and the glass substrate 32. The transparent adhesive can be formed between the first antireflection layer 31 and the glass substrate 32, between the glass substrate 32 and the electromagnetic shielding layer 34, between the electromagnetic shielding layer 34 and the near infrared shielding layer 36, and between the near infrared shielding layer 36 and the second antireflection layer 37.

As aforementioned, in the front filter of the PDP and the fabrication method thereof, the frame adhesive composed of the transparent adhesive formed at an area that is overlapped with the active display area of the plasma display panel and the black adhesive formed at an area except the active display area is formed on at least one thin film among a plurality of thin films constituting the front filter of the plasma display panel, thereby correctly and easily forming the active display area of the plasma display panel.

Also, in the front filter of the PDP and the fabrication method thereof according to the present invention, the active display area of the PDP can be correctly and easily formed not only at the glass type front filter but also at the filter type front filter.

Additionally, in the front filter of the PDP and the fabrication method thereof according to the present invention, the conventional additional process for forming the black frame is not necessary, thereby simplifying processes and reducing a material cost of the front filter.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A front filter of a plasma display panel, in the front filter attached to a front surface of the plasma display panel and formed of a plurality of thin films, the front filter is formed on at least one thin film among the plurality of thin films and includes a frame adhesive for forming an active display area of the plasma display panel.
